(19) United States
(12) Patent Application Publication
(10) Pub. No.: US 2006/0000437 A1
(43) Pub. Date: Jan. 5, 2006

(54) Intake manifold for internal combustion engine and method for manufacturing the same

(76) Inventors: Kazuyori Kito, Kanagawa (JP); Tsuyoshi Osawa, Kanagawa (JP)

Correspondence Address: HARNESS, DICKEY & PIERCE, P.L.C., P.O. BOX 8910, RESTON, VA, 20195, US

(21) Appl. No.: 11/186,760

(22) Filed: Jul. 22, 2005

(30) Foreign Application Priority Data
Jun. 30, 2004 (JP) 2004-223614

(51) Int. Cl. F02M 35/10

(52) U.S. Cl. 123/184.21; 123/184.42

(57) ABSTRACT

A method for forming an intake manifold including a flame arrestor for an internal combustion engine, and an intake manifold for an internal combustion engine including a base member, a cover member, and a flame arrestor, wherein the flame arrestor is inserted into the base member or the cover member and fastened into a desired location by the connection between the base member and cover member. The cover member and base member are connected together by vibration welding or any other suitable connection.

### PRIORITY STATEMENT

This non-provisional U.S. Application claims priority under 35 U.S.C. § 119 to Japanese Application No. 2004-223614 filed on Jul. 30, 2004, the entire contents of which are herein incorporated by reference.

### BACKGROUND OF THE INVENTION

1. Field of the Invention

Example embodiments of the present invention relate to an intake manifold for an internal combustion engine including a flame arrestor incorporated into a main body. The intake manifold may include a base member, a cover member, and a flame arrestor may be inserted into either the base member or the cover member and fastened in a desired position by a connection between the base member and cover member. The intake manifold including the flame arrestor may be manufactured by inserting the flame arrestor into either the base member or the cover member and fastening the flame arrestor in a desired position by joining the base member with the cover member.

2. Description of the Related Art

An intake manifold used to introduce intake air into the respective cylinders may be installed in the intake system of an engine, for example, a multi-cylinder, four-cycle internal combustion engine. Internal combustion engines that may be mounted on outboard motor watercraft and personal watercraft (PWC) such as water bikes or similar vehicles that travel over water, may require installation of a flame arrestor used to prevent backfiring from the cylinder combustion chambers. However, an intake manifold including a flame arrestor may also be incorporated into a variety of other engines and/or other vehicles for a variety of reasons.

Conventionally, as shown in FIG. 7, the intake manifold 101 may be constructed as an integral unit using metal casting and/or similar techniques, and a flame arrestor 112 may be incorporated into an attachment flange 103 which may be integrally formed on one end of the manifold in the longitudinal direction. As shown in the related example of FIG. 8, a circular engaging recess 113 may be formed in the attachment flange 103 of the intake manifold 101, and a cylindrical flame arrestor 112 may be installed and/or fastened in the engaging recess 113.

However, in the related example in which a flame arrestor 112 may be installed on the attachment flange 103 of the intake manifold 101 from the outside as shown in FIGS. 7 and 8, the opening diameter of the attachment part (internal diameter of the engaging recess 113)φD may be increased, and a space may be included for the formation of a plurality of screw holes 104 (e.g., four screw holes in the example shown in the FIGS. 7 and 8). The screw holes may accommodate bolts for attaching an intake throttle vale (not shown) to the attachment flange 103. The intake throttle vale protects the surface of the flame arrestor 112 that may abut against the engaging recess 113 of the attachment flange 103. Therefore, the external diameter φd of the attachment flange 103 may be increased, thus creating several problems. One example of a problem is that the increased external diameter may translate into increased size and/or weight of the intake manifold, thereby making reduction of the size and/or weight of the intake manifold 101 difficult to achieve. Further, because the flame arrestor 112 may be inserted and/or engaged in the engaging recess 113 of the attachment flange 103 of the intake manifold 101, the external diameter φD0 of the flame arrestor 112 may be set so that the diameter φD0 may be equal to or less than the opening diameter of the attachment part (internal diameter of the engaging recess 113), e.g., φD (φD0≦φD).

In a prior art example shown in FIG. 9, a flame arrestor 212 may be inserted into a long, slender tubular member 230 before the tubular member 230 is inserted from one direction into the intake manifold 201. Therefore, the prior art example shown in FIG. 9 may require an increased number of components. The increased number of components may also increase the size and/or weight intake manifold 201 making reduction of the size and/or weight of the intake manifold 201 difficult to achieve.

In another related example a flame arrestor may be installed inside the intake manifold from an opening at one end of the intake manifold. However, if the flame arrestor is installed from an opening at one end of the intake manifold, the flame arrestor is likely installed using a long guide from the open side of the intake manifold (the opposite side of the attachment flange from where the intake throttle valve may be installed). Accordingly, the related example may result in increased installation time and/or difficulty.

### SUMMARY OF THE INVENTION

Example embodiments of the present invention provide an intake manifold for an internal combustion engine which eases the incorporation of a flame arrestor into an intake manifold, and may allow a reduction in size and/or weight of the intake manifold.

One example embodiment of the present invention may provide an intake manifold for an internal combustion engine in which a flame arrestor may be incorporated into the main body. The intake manifold may be constructed from at least a base member and a cover member by dividing the main body into a plurality of parts by means of split surfaces that approximately correspond to a horizontal plane of the main body. The flame arrestor may be incorporated inside the base member from an opening of the base member. The flame arrestor may be clamped by the base member and the cover member that may be joined with the base member, so that the flame arrestor may be fastened in a desired location.

Another example embodiment may include an engaging recess that may be formed inside an attachment flange formed on one end of the base member in the longitudinal direction. In an example embodiment, the flame arrestor may be inserted and engaged in an engaging recess. Further, the flame arrestor may be pressed by a pressing part formed on one end of the cover member in the longitudinal direction so that the flame arrestor may be fastened in place.

In another example embodiment, the flame arrestor may be formed with a cylindrical shape; the engaging recess in the attachment flange with which the flame arrestor may be engaged may be formed in the shape of a circular hole; and the pressing part of the cover member may be formed with a ring shape so that the outer circumferential edge part of the flame arrestor may be pressed by the pressing part.

In another example embodiment, the internal diameter of the attachment flange formed on the base member may be set so that the internal diameter of the attachment flange is smaller than the external diameter of the flame arrestor.

In another example embodiment, the cover member may be connected to the base member by a vibration weld.

In another example embodiment, an intake manifold for an internal combustion engine may include a first member, a second member, and a flame arrestor that may be inserted into the first member or second member and may be fastened at a desired position by a connection between the first member and the second member. One of the first member and the second member may be a base member and the other of the first member and the second member may be a cover member.

In another example embodiment, an intake manifold including a flame arrestor for an internal combustion engine may be formed by inserting the flame arrestor into a first member and fastening the flame arrestor in a desired position by joining the first member with the second member. One of the first member and the second member may be a base member and the other of the first member and the second member may be a cover member.

According to the above summary of the example embodiments of the present invention, the flame arrestor may be installed inside the base member and may be clamped and/or fastened in place by the base member and the cover member that may be mounted on the base member so as to cover an opening of the base member.

Furthermore, because there may be no need to ensure a large abutting area for the flame arrestor to abut against the engaging recess of the attachment flange as in the previously described related example in which the flame arrestor may be installed in the attachment flange of the intake manifold via an external opening of an attachment flange arranged on the intake manifold, the external diameter of the attachment flange may be kept to a small dimension, which may result in the size and/or weight of the intake manifold being reduced.

Further, according to the above summary of the example embodiments, the flame arrestor may be inserted and/or engaged in an engaging recess formed inside the attachment flange via a base member opening. The flame arrestor may be pressed and/or fastened in place by the pressing part arranged on the cover member and/or base member. The flame arrestor may be securely fastened inside the intake manifold, so that the air-tight sealing properties of the outer circumferential part of the flame arrestor may be increased, thereby possibly eliminating the need for packing material that is conventionally mounted on the outer circumference of the flame arrestor in order to ensure a relatively air-tight seal.

Further, according to the above summary of the example embodiments, because the internal diameter of the attachment flange arranged on or as part of the base member and/or cover member may be set at a value smaller than the external diameter of the flame arrestor, the attachment flange and the external diameter of the throttle body attached to the attachment flange may be kept to a small size. The smaller size of the internal diameter of the attachment flange may allow a reduction in the size and/or weight of the engine intake system including the intake manifold and throttle body.

Still further, according to the above summary of the example embodiments, the cover member may be easily and/or securely joined to the base member by vibration welding, so that an intake manifold may be constructed by closing an opening of the base member used to install the flame arrestor with the cover member.

It is to be understood that both the foregoing general description of example embodiments of the invention and the following detailed description of example embodiments of the present invention are not intended to be restrictive of the present invention.

### BRIEF DESCRIPTION OF THE DRAWINGS

Example embodiments of the present invention will become more apparent and more readily appreciated from the following detailed description taken in conjunction with the accompanying figures. However, the figures may not be necessarily to scale, emphasis instead being placed upon illustrating the principles of example embodiments of the present invention. Like reference characters refer to like elements throughout the figures.

FIG. 1 is a plan view of an intake manifold according to an example embodiment of the present invention;

FIG. 2 is a sectional view along line A-A in FIG. 1;

FIG. 3 is a view in the direction indicated by arrow B in FIG. 1;

FIG. 4 is a view in the direction indicated by arrow C in FIG. 1;

FIG. 5 is a longitudinal sectional view showing the base member and cover member formed by splitting the intake manifold of an example embodiment of the present invention in two parts;

FIG. 6 is an exploded perspective view showing the procedure for installing the flame arrestor in the intake manifold of an example embodiment of the present invention;

FIG. 7 is a perspective view showing the installation procedure of the flame arrestor in a related intake manifold;

FIG. 8 is a partial sectional view of the flame arrestor attachment part (attachment flange part) of a related intake manifold; and

FIG. 9 is a sectional view of an engine intake system showing a prior art example of a structure used to attach the flame arrestor to the intake manifold.

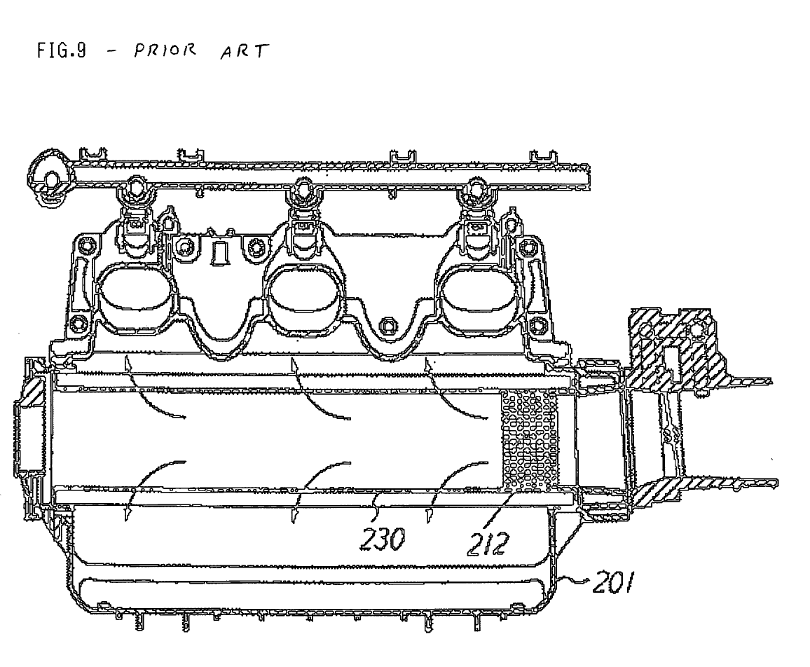

### DESCRIPTION OF EXAMPLE EMBODIMENTS OF THE PRESENT INVENTION

Example embodiments of the present invention will be described below with reference to the attached figures.

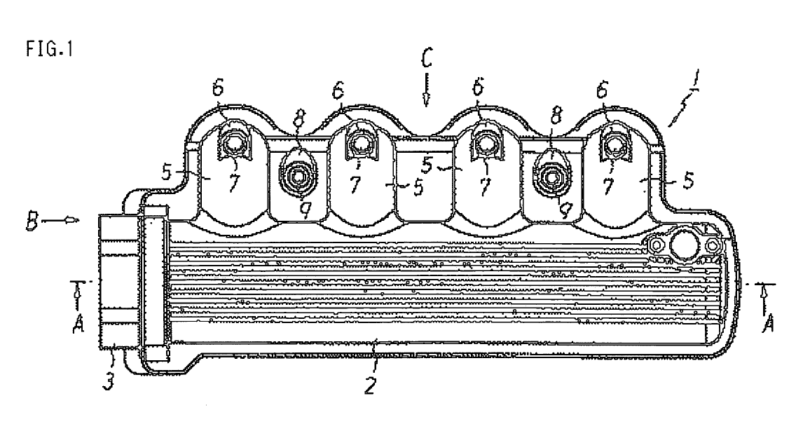

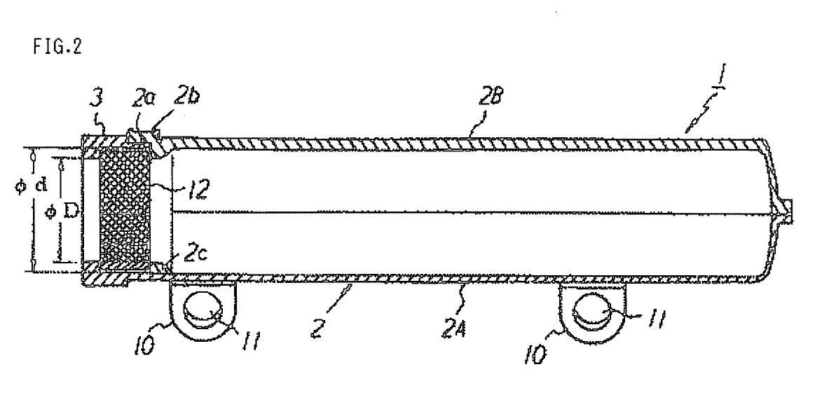

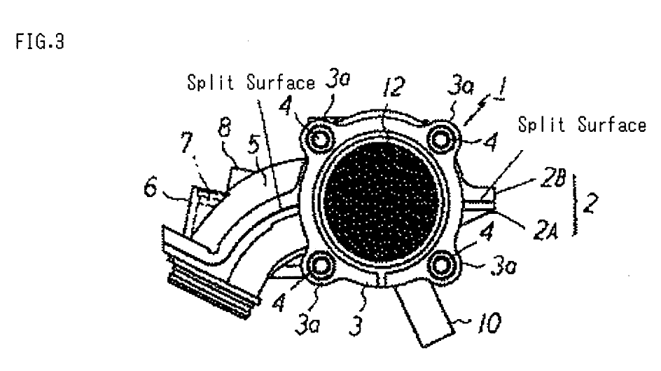

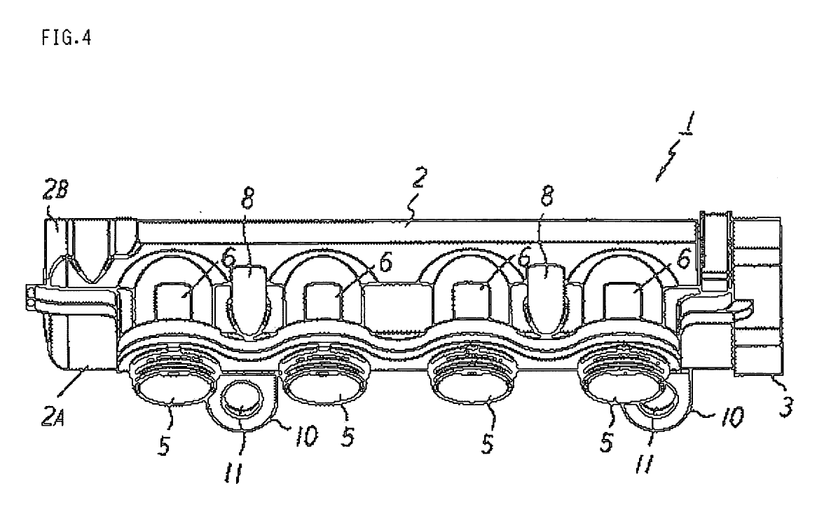

FIG. 1 is a plan view of the intake manifold of an example embodiment of the present invention, FIG. 2 is a sectional view along line A-A in FIG. 1, FIG. 3 is a view in the direction indicated by arrow B in FIG. 1, and FIG. 4 is a view in the direction indicated by arrow C in FIG. 1.

The intake manifold 1 of an example embodiment may be installed in the intake system of an engine, for example, a four-cycle four-cylinder engine for use in PWC. One end (in the longitudinal direction) of the main body 2, which may be formed in a tubular shape from a synthetic resin or any other suitable material may be closed off, while the other end may be left open. An attachment flange 3 may be integrally formed on the open end of the main body 2, and an intake throttle valve (not shown) may be attached to the attachment flange 3. For example, as shown in FIG. 3, metal screws 4 may be inserted into semi-cylindrical boss parts 3a which may be integrally formed in four places on the outer circumferential part of the attachment flange 3, and the throttle body (not shown) may be attached to the attachment flange 3 by bolts (not shown) passed through four circular (for example) holes (not shown) formed in the throttle body into the abovementioned screws 4 inserted in the attachment flange 3. Furthermore, the intake throttle valve may be connected to a silencer (not shown). The intake throttle valve and attachment flange 3 may be attached in a variety of ways, and the description above is not meant to limit the example embodiment of the present invention.

Furthermore, four elbow-shaped (for example) intake pipes 5 may be integrally disposed side by side in the longitudinal direction on the side of the main body 2 of the intake manifold 1. The respective intake pipes 5 may be connected to the intake ports of the respective cylinders formed in the cylinder head of the engine main body (not shown).

Furthermore, attachment seats 6 used to attach injectors (not shown) may be respectively integrally formed in the respective intake pipes 5, and insertion holes 7 (see FIGS. 1 and 3) that may be used to insert the injectors may be formed through the respective attachment seats 6. Furthermore, separate attachments seats 8 may be integrally formed in two places between adjacent intake pipes 5 of the main body 2 and screw holes 9 (see FIG. 1) used for attaching fuel rails (not shown). The fuel rails (not shown) may be formed in the respective attachment seats 8. Furthermore, as shown in FIGS. 2-4, attachment brackets 10 may protrude downward (for example) at an inclination as integral units from two (for example) places in the longitudinal direction on the undersurface of the main body 2, and round (for example) holes 11 may be respectively formed in the respective attachment brackets 10.

Furthermore, a flame arrestor 12 may be installed inside the intake manifold 1 of the example embodiment. In the example embodiment, the flame arrestor 12 may be installed inside the main body 2 using an example embodiment of an attachment structure as described below.

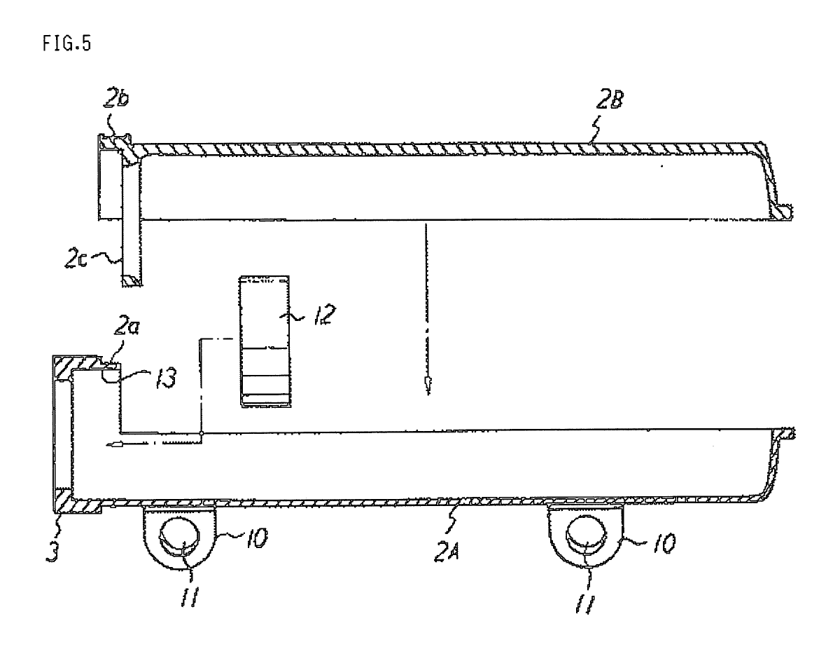

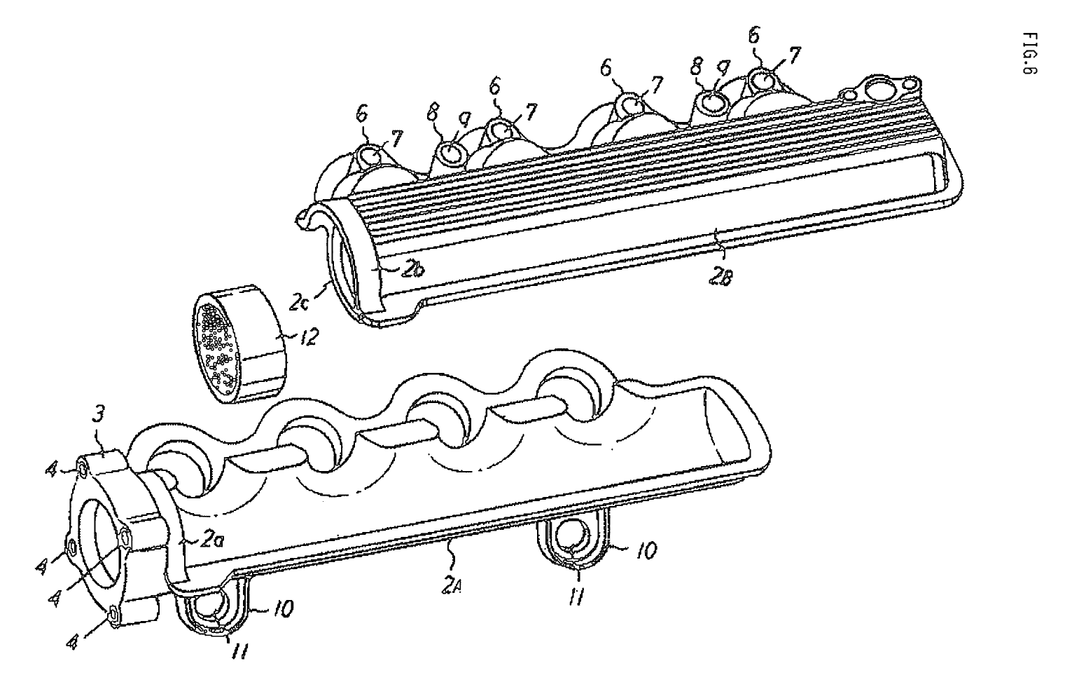

The attachment structure of the flame arrestor 12 of the example embodiment may be described with reference to FIGS. 5 and 6. FIG. 5 is a sectional view showing the base member and cover member formed by splitting the intake manifold in two parts, and FIG. 6 is an exploded perspective view of the intake manifold showing the installation procedure for installing the flame arrestor according to an example embodiment of the present invention. The intake manifold according to the example embodiments of the present invention may be integrally formed and then split into multiple parts including, for example, a base member and/or cover member. Alternatively, the intake manifold may be constructed from separately formed multiple parts, including, for example, a base member and/or cover member.

For example, the main body 2 of the intake manifold 1 may be constructed from a base member 2A and a cover member 2B. As shown in the example embodiment of FIG. 3, the base member 2A may be located below a split surface and the cover member 2B may be located above a split surface. The split surface may approximately correspond with a horizontal plane passing through the central axis of the main body 2. The attachment flange 3 may be formed at one end of the main body. As shown in FIG. 3, the attachment flange 3 may be integrally formed on the base member 2A. The respective intake pipes 5 may be split into upper and lower parts, and the upper and lower parts may be integrally formed on the base member 2A and cover member 2B, respectively (see the example embodiment in FIG. 6).

Furthermore, a circular engaging recess 13 may be formed inside the attachment flange 3 formed on one end of the base member 2A in the longitudinal direction. A half-ring engaging step part 2a may be integrally formed inside the attachment flange 3 in the longitudinal direction. Moreover, a half-ring engaging cover part 2b which may engage with the outer circumferential surface of the abovementioned engaging step part 2a of the base member 2A may be integrally formed on one end of the cover member 2B in the longitudinal direction (e.g., the end on the side of the attachment flange 3 of the base member 2A). A ring-shaped pressing part 2c may also be integrally formed approximately perpendicular to a horizontal plane approximately corresponding to the central axis of the main body 2 in the interior of the main body 2.

The flame arrestor 12 may be constructed as a honeycomb, cylindrical body by wrapping a stainless steel metal foil formed as a corrugated sheet. The flame arrestor 12 may be installed inside the base member 2A from an opening and inserted and/or engaged in the engaging recess 13 that may be formed inside the attachment flange 3.

Next, the abovementioned cover member 2B may be connected to the base member 2A so that the opening of the base member 2A is closed, and the split surfaces of both the base member 2A and cover member 2B are joined. The engaging cover part 2b formed as part of cover member 2B may engage the engaging step part 2a formed as part of the base member 2A from above. Then, in this state, the split surfaces of the base member 2A and cover member 2B may be vibration welded together so that both parts may be formed into an integral unit, e.g., an intake manifold 1 with a flame arrestor 12 installed inside as shown in the example embodiment of FIG. 2.

In an example embodiment, the outer circumferential edge of the flame arrestor 12 may be pressed by a ring-shaped pressing part 2c formed as part of the cover member 2B. Accordingly, the flame arrestor 12 may be fastened between the base member 2A and cover member 2B inside the engaging recess 13, so that the position of the flame arrestor 12 in the longitudinal direction (axial direction) may be regulated.

The flame arrestor 12 may be installed inside the intake manifold 1 in accordance with the abovementioned procedure. As shown in the example embodiment of FIG. 2, the internal diameter φD of the attachment flange 3 may be set so that internal diameterφD is smaller than the external diameter φd of the flame arrestor 12 (φD<φd).

In an example embodiment of the present invention, vibration welding may be employed to join cover member 2B to base member 2A. However, one skilled in the art will appreciate that the cover member 2B and base member 2A may be joined using a variety of techniques, for example bolting together the cover member 2B and base member 2A.

When the engine (not shown) is started, fresh air may be introduced into the intake manifold 1 via the flame arrestor 12 (after the amount of intake air is adjusted by the intake throttle valve (not shown)) by the intake negative pressure that may be generated in the respective cylinders of the engine (not shown), and may be supplied to the engine via the respective intake pipes 5 of the intake manifold 1. During this process, fuel may be injected from the injectors (not shown) so that a mixture having a specified air-fuel ratio may be formed. Then, the mixture may be supplied to the respective cylinders via the intake ports of the engine and used in combustion in the cylinder combustion chambers of the respective cylinders. In an example embodiment, backfiring from the cylinder combustion chambers may be securely blocked by the flame arrestor 12, so that a flame does not flow back to the intake throttle valve, which may cause various problems.

In an example embodiment, because the main body 2 of the intake manifold 1 may be split in two parts by split surfaces that may approximately correspond to the abovementioned horizontal plane, the flame arrestor 12 may be installed inside the base member 2A through an opening of the base member 2A. The flame arrestor 12 may subsequently be clamped and/or fastened in place by the base member 2A and the pressing part 2c installed as part of the cover member 2B which may be mounted on the base member 2A so as to cover the opening of the base member 2A. Accordingly, installing and/or fastening the flame arrestor 12 into the base member 2A is made easier.

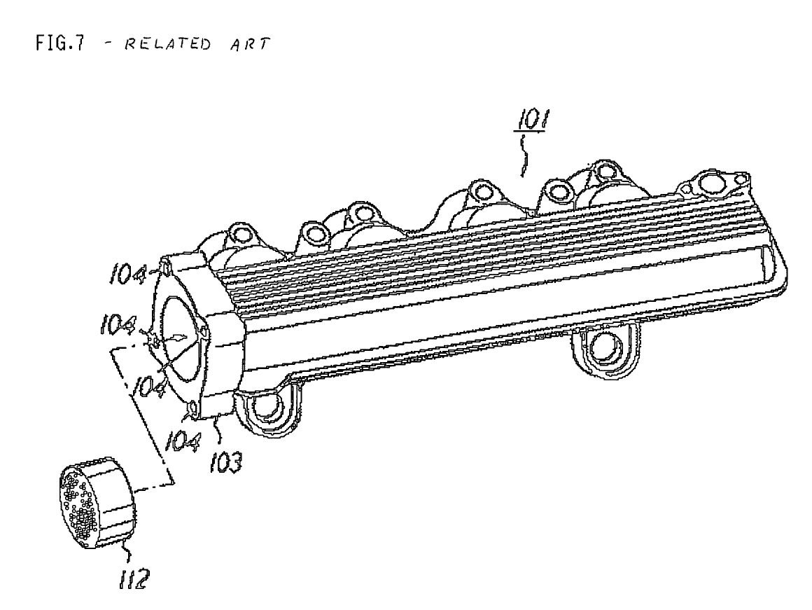

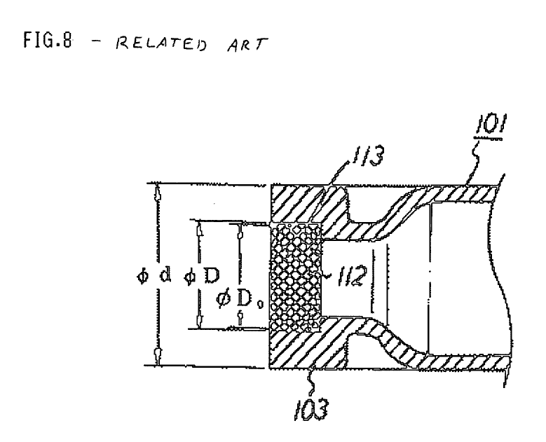

Furthermore, because there may be no need to ensure a large abutting surface of the flame arrestor 12 against the engaging recess 13 of the attachment flange 3 as in the related examples illustrated in FIGS. 7 and 8, in which the flame arrestor 12 may be installed inside the attachment flange 3 via an external opening of the attachment flange, the external diameter of the attachment flange 3 according to example embodiments of the present invention shown in FIGS. 1-6 may be kept to a small diameter. A result of the small diameter may be a reduction in the size and/or weight of the intake manifold 1.

Furthermore, according to example embodiments of the present invention, the flame arrestor 12 may be inserted and/or engaged in an engaging recess 13 formed inside the attachment flange 3 of the base member 2A, and fastened in a desired location by the pressing part 2c arranged on or as part of the cover member 2B. Accordingly, the flame arrestor 12 may be securely fastened inside the intake manifold 1, and the air-tightness of the outer circumferential part of the flame arrestor 12 is increased, so that the packing material conventionally mounted on the outer circumference of the flame arrestor 12 in order to ensure air-tightness may be omitted.

Furthermore, because the internal diameter φD of the attachment flange 3 formed on the base member 2A may be set so that the internal diameter φD is smaller than the external diameter φd of the flame arrestor 12 (φD<φd) (as described above), the attachment flange 3 and the external diameter of the intake throttle valve installed on the flange may be kept to a smaller size so that the size and/or weight of the engine intake system including the intake manifold 1 and intake throttle valve may be reduced.

Furthermore, because the size (external diameter φd) of the flame arrestor 12 may be freely set without regard to the size of the intake throttle valve, the degree of freedom in design may be increased.

Furthermore, in example embodiments of the present invention, the cover member 2B may be easily and/or securely mounted on the base member 2A by vibration welding, so that an intake manifold 1 may be constructed by closing off the opening of the base member 2A used to install the flame arrestor 12 with the cover member 2B. Because the flame arrestor 12 is a maintenance-free part, there may be no need to subsequently disassemble the intake manifold 1 and remove the flame arrestor 12 once the flame arrestor 12 has been installed inside the intake manifold 1. Accordingly, the cover member 2B may be joined to the base member 2A by vibration welding and/or any other suitable technique.

Furthermore, in the example embodiments of the present invention described above, the flame arrestor 12 may be formed having a cylindrical shape. However, this shape is arbitrary, and may also be a polygonal column such as a square column, triangular column or the like, for example.

Furthermore, in the example embodiments described above, the flame arrestor 12 may be disposed at right angles to the flow of the intake air. However, the flame arrestor 12 may be inclined so the flame arrestor 12 is oriented obliquely with respect to the flow of the intake air, thereby increasing the degree of freedom in design.

Furthermore, in the example embodiments, a ring-shaped pressing part 2c may be arranged on or as part of the cover member 2B, and the entire circumferential edge part of the flame arrestor 12 may be pressed by the pressing part 2c. However, the pressing part may be formed in different shapes, for example, square, rectangular, circular. Still further, the pressing part may be formed to press only a portion of the flame arrestor, for example, a bottom half, top half, and/or middle portion of the flame arrestor.

Furthermore, in the example embodiments, the base member 2A and cover member 2B constituting the intake manifold 1 may be constructed from a synthetic resin. However, the base member and/or cover member may be constructed from metal castings and/or similar techniques using a variety of suitable materials. In any case, because it may be necessary to form an engaging recess 13 inside the attachment flange 3 of the base member 2A, it may be necessary to slide the mold in the axial direction following molding so that this mold may be removed.

Obviously, numerous modifications and variations of the example embodiments of the present invention are possible in light of the above teachings. It is therefore to be understood that within the scope of the appended claims, the invention may be practiced otherwise than as specifically described herein.

For example, the teachings as described using example embodiments relating to multi-cylinder, four cycle internal combustion engines are applicable to other internal combustion engines as well as other vehicles and/or apparatuses including but not limited to boats, cars, and motorcycles.

What is claimed is:

1. An intake manifold for an internal combustion engine comprising:
a flame arrestor; and
a main body,
wherein the intake manifold includes at least a base member and a cover member separated along split surfaces, the flame arrestor arranged on the base member and fastened in place by a connection between the base member and the cover member.

2. The intake manifold for an internal combustion engine according to claim 1, further comprising:
an attachment flange;
an engaging recess; and
a pressing part, wherein
the engaging recess is located inside the attachment flange arranged on one end of the base member in a longitudinal direction, and
the flame arrestor is arranged in the engaging recess and contacts the pressing part arranged on one end of the cover member in the longitudinal direction.

3. The intake manifold for an internal combustion engine according to claim 2, wherein the flame arrestor has a cylindrical shape, the engaging recess has a circular shape, and the pressing part has a ring shape so that the outer circumferential edge part of the flame arrestor contacts the pressing part.

4. The intake manifold for an internal combustion engine according to claim 2, wherein the internal diameter of the attachment flange arranged on the base member is smaller than an external diameter of the flame arrestor.

5. The intake manifold for an internal combustion engine according to claim 1, wherein a vibration weld joins the cover member with the base member.

6. An intake manifold for an internal combustion engine comprising:
a first member;
a second member; and
a flame arrestor inserted into the first member and fastened at a desired position by a connection between the first member and the second member.

7. The intake manifold according to claim 6, further comprising:
an attachment flange arranged on one end of the first member and including an interior engaging recess,
wherein the flame arrestor is inserted into the engaging recess of the attachment flange.

8. The intake manifold according to claim 7, wherein the attachment flange and first member are integrally formed.

9. The intake manifold according to claim 7, further comprising:
a pressing member configured to press the flame arrestor against an interior side of the attachment flange.

10. The intake manifold according to claim 9, wherein the pressing member is arranged on the second member.

11. The intake manifold according to claim 10, wherein the pressing member is integrally formed with the second member.

12. The intake manifold according to claim 9, wherein the flame arrestor has a cylindrical-shape.

13. The intake manifold accordingly to claim 12, wherein the pressing member has a ring-shape and is configured to contact an outer circumferential edge of the flame arrestor.

14. The intake manifold according to claim 7, wherein an internal diameter of the attachment flange is smaller than an external diameter of the flame arrestor.

15. The intake manifold according to claim 6, further comprising:
a vibration weld joining the first member and second member.

16. The intake manifold according to claim 6, wherein one of the first member and the second member is a base member and the other of the first member and the second member is a cover member.

17. A method for forming an intake manifold including a flame arrestor for an internal combustion engine, the method comprising:
inserting the flame arrestor into a first member;
fastening the flame arrestor in a desired position by joining the first member with a second member.

18. The method according to claim 17, wherein the joining the first member with the second member includes vibration welding the first member to the second member.

19. The method according to claim 18, wherein the inserting includes inserting the flame arrestor into a first member via an opening in the first member and the joining closes the opening.

20. The method according to claim 17, wherein one of the first member and the second member is a base member and the other of the first member and the second member is a cover member.
